(19) United States
(12) Patent Application Publication
(10) Pub. No.: US 2014/0080964 A1
(43) Pub. Date: Mar. 20, 2014

(54) GLUE, ITS USAGE AND METHOD FOR APPLYONG ON A PVC FLOOR

(71) Applicants: TEX YEAR FINE CHEMICAL (GUANGZHOU) CO., LTD, Guangzhou (CN); Huidong Weikang Rubber and Plastic Products Co., Ltd., Huizhou City (CN)

(72) Inventors: Yuanyang LI, Huizhou City (CN); Bingkang LIANG, Huizhou City (CN); Hsin-Huei WANG, Taipei City (TW)

(73) Assignees: TEX YEAR FINE CHEMICAL (GUANGZHOU) CO., LTD, Guangzhou (CN); Huidong Weikang Rubber and Plastic Products Co., Ltd., Huizhou City (CN)

(21) Appl. No.: 14/030,244

(22) Filed: Sep. 18, 2013

(30) Foreign Application Priority Data
Sep. 18, 2012 (CN) 201210345156.4

(51) Int. Cl. C09J 123/26

(52) U.S. Cl. CPC C09J 123/26
USPC 524/505

(57) ABSTRACT

A glue is provided comprising by weight: styrene-ethylene/butylene-styrene block copolymer 15-30%; amorphous poly alpha olefin 2-20%; hydrogenated petroleum resin 20-40%; liquid isobutylene homopolymer 1-10%; mineral oil 20-50%; and antioxidants 0.1-2%. The glue has high strength when cured but low viscosity. When serving as back-glue of PVC flooring, it has greater bonding force to the PVC flooring than to the ground. The glue will not be damaged by the ground, and there will be no adhesive residue attached to the ground when the floor coverings are separated from the ground due to some reasons such as misplacement. Therefore the glue can be resistant to repeated tiling. In the meantime, the floor coverings, such as a PVC floor, will not be damaged after separation from the ground due to misplacement.

### CROSS-REFERENCE TO RELATED DOCUMENTS

The present invention claims benefits from Chinese patent tiling No. 201210345156.4 filed on Sep. 18, 2012 in the name of Huidong Weikang Rubber and Plastic Products Co., Ltd., the disclosure of which is incorporated herein by reference in its integrity.

### FIELD OF THE INVENTION

The present invention relates to glue, its usage and a method for applying on a PVC floor.

### BACKGROUND OF THE INVENTION

PVC (polyvinyl chloride) floor coverings (also called PVC floor) are currently widely used in building decoration. PVC floor coverings are floors that are made from polyvinyl chloride materials, specifically from polyvinyl chloride and its copolymer resin with addition of fillers, plasticizers, stabilizers, colorants and other auxiliary materials, by calendaring, extruding or hydraulic molding. PVC floor covering has some advantages compared with other flooring, such as easy to installation, without need of welding, abrasion resistance, anti-skidding, long service life, good appearance, flexibility, environment-friendly and formaldehyde-free, acoustic noise reduction, good foot comfortability, colorful, light weight, pattern comfortable and etc. It also can show as stone, metal, wood and abstract pattern.

As PVC floor coverings are subjected to thermal expansion and cold contraction in response to room temperature changes, when installing PVC floorings, it is needed to coat a layer of glue at the bottom surface of the floor (industrially called back-glue) to avoid floor curling or displacement due to thermal expansion or cold contraction. Currently, conventional flooring bonding glue can be used once. It is needed to separate the floor covering from the ground if dislocation occurs, which may cause the floor covering destroyed, and sometime it is difficult to separate. This adversely affects the install process and causes floor scrap. Moreover, the glue residue on the ground is hard to clean.

### BRIEF SUMMARY OF THE INVENTION

An object of the present invention is to provide a glue with high strength when cured and that is suitable for repeated tiling and separation.

Another object of the present invention is to provide a usage of the glue.

A further object of the present invention is to provide a method for using the glue on a PVC flooring.

To achieve these and other objects, a glue is provided comprising by weight: styrene-ethylene/butylene-styrene block copolymer 15-30%; amorphous poly alpha olefin 2-20%; hydrogenated petroleum resin 20-40%; liquid isobutylene homopolymer 1-10%; mineral oil 20-50%; and antioxidants 0.1-2%.

In one embodiment, hydrogenated petroleum resin has a softening point between 120° C. and 140° C.

In another aspect, the glue is applied to a backside of a PVC floor as a back-glue before it is cured.

In still another aspect, a method for using the glue is disclosed which comprises a step of applying the glue to a bottom surface of a piece of PVC floor under a temperature of 150-180° C.

In the composition of the glue, the styrene-ethylene/butylene-styrene block copolymer (SEBS) is contained for providing glue strength, and increasing the cohesion value of the glue. SEBS has few unsaturated bonds and is unlikely to pyrolysis, imparting the glue with good stability and weather resistance, such that the glue can be resistant to repeated separation and tiling without losing viscosity. Furthermore, SEBS is to some extent resistant to plasticizers contained in PVC floorings to prevent the glue from cracking due to the existence of plasticizers and thus avoid production of glue residues.

The hydrogenated petroleum resin is used to increase the adhesive strength when it is applied to the ground. If the hydrogenated petroleum resin is absent, the glue would not have the performance of bonding ground. The mineral oil is present to reduce the viscosity of the glue.

The antioxidants are present to enhance thermal stability of the glue and prevent the glue from aging and decomposition during usage.

The invention has the following advantages. The glue disclosed in the present invention has high strength when cured but low viscosity. This is achieved by specific formulation of the ingredients contained in the glue, and selection of suitable softening point of the hydrogenated petroleum resin. When serving as back-glue of PVC flooring, it has greater bonding force to the PVC flooring than to the ground. The glue will not be damaged by the ground, and there will be no adhesive residue attached to the ground when the floor coverings are separated from the ground due to some reasons such as misplacement. Therefore the glue can be resistant to repeated tiling. In the meantime, the floor coverings, such as a PVC floor, will not be damaged after separation from the ground due to misplacement.

### DETAILED DESCRIPTION OF THE INVENTION

The present invention will be further described in detail with the reference of the preferable embodiments which shall not be constructed to be limiting the scope of the invention.

### EXAMPLE 1

A glue is comprised of the following ingredients in weight percentage:

| | |
|---|---|
| styrene-ethylene/butylene-styrene block copolymer | 25% |
| amorphous poly alpha olefin | 5% |
| hydrogenated petroleum resin with softening point 120-140° C. | 40% |
| liquid isobutylene homopolymer | 4% |
| mineral oil | 25%, and |
| antioxidants | 1%. |

The glue of this example is prepared by steps of feeding the ingredients in sequence into a kneader; stirring the mixture at a high temperature (120-160° C.) until the mixture is uniformly dispersed; evacuating to eliminate air bubbles in the mixture; and extruding the molding using an extruding machine.

### EXAMPLE 2

A glue is comprised of the following ingredients in weight percentage:

| | |
|---|---|
| styrene-ethylene/butylene-styrene block copolymer | 16% |
| amorphous poly alpha olefin | 20% |
| hydrogenated petroleum resin with softening point 120-140° C. | 25% |
| liquid isobutylene homopolymer | 2% |
| mineral oil | 36.7%, and |
| antioxidants | 0.3%. |

The production process of the glue of this example is the same as that of the glue in Example 1.

### EXAMPLE 3

A glue is comprised of the following ingredients in weight percentage:

| | |
|---|---|
| styrene-ethylene/butylene-styrene block copolymer | 28% |
| amorphous poly alpha olefin | 3% |
| hydrogenated petroleum resin with softening point 120-140° C. | 32% |
| liquid isobutylene homopolymer | 8% |
| mineral oil | 28%, and |
| antioxidants | 1%. |

The production process of the glue of the present example is the same as that of the glue in Example 1.

### EXAMPLE 4

A glue is comprised of the following ingredients in weight percentage:

| | |
|---|---|
| styrene-ethylene/butylene-styrene block copolymer | 20% |
| amorphous poly alpha olefin | 8% |
| hydrogenated petroleum resin with softening point 20-140° C. | 25% |
| liquid isobutylene homopolymer | 3% |
| mineral oil | 42%, and |
| antioxidants | 2%. |

The production process of the glue of this example is the same as that of the glue in Example 1.

### COMPARISON EXAMPLE 1

A glue is comprised of the following ingredients in weight percentage:

| | |
|---|---|
| styrene-ethylene/butylene-styrene block copolymer | 25% |
| amorphous poly alpha olefin | 5% |
| unhydrogenated petroleum resin with low softening | 40% |
| point (<120° C.) | |
| liquid isobutylene homopolymer | 4% |
| mineral oil | 25%, and |
| antioxidants | 1%. |

The glue of this comparison example is prepared in the same way as that of the glue Example 1.

COMPARISON EXAMPLE 2

A glue is comprised of the following ingredients in weight percentage:

| | |
|---|---|
| styrene-isoprene-styrene block copolymer (SIS) | 25% |
| amorphous poly alpha olefin | 5% |
| hydrogenated petroleum resin with softening point 120-140° C. | 40% |
| liquid isobutylene homopolymer | 4% |
| mineral oil | 25%, and |
| antioxidants | 1%. |

The glue of this comparison example is prepared in the same way as that of the glue Example 1.

The glues provided in Examples 1-4 and Comparison Examples 1-2 are compared to regularly used back-glue, type 905B glue from Deyuan Enterprise Co., Ltd. as control, with respect to annular viscosity and peel strength at 180° C. Methods and results for the comparison are summarized in the table immediately below.

| Test | Mate- | | Ex. | Ex. | Ex. | Ex. | Comp. | Comp. | Con- |
|---|---|---|---|---|---|---|---|---|---|
| items | rials | Unit | 1 | 2 | 3 | 4 | Ex. 1 | Ex. 2 | trol |
| annular | PET- | Kgf/ | 0.9 | 0.9 | 0.8 | 0.8 | 1.6 | 3.0 | 1.5 |
| viscosity | steel | in | | | | | | | |
| | PET-PP | | 0.9 | 1.0 | 0.9 | 1.0 | 1.5 | 2.6 | 1.6 |
| 180° C. | PET- | | 1.2 | 1.1 | 1.0 | 1.2 | 2.3 | 4.0 | 3.0 |
| peel | steel | | | | | | | | |
| strength | PET-PP | | 1.1 | 1.1 | 1.0 | 1.2 | 2.1 | 3.5 | 2.7 |

Notes:
1. annular viscosity test is carried out under standard JIS Z 0237. Glue thickness 0.09 mm.
2. peel strength test at 180° C. is carried out under standard PSTC-1. Glue thickness 0.09 mm.

It can be seen from e table that the viscosity of the glues in Examples 1-4 is lower than the regularly used glue. Due to the use of unhydrogenated petroleum resin with low softening point (<120° C.) in Comparison Example 1 and the use of styrene-isoprene-styrene block copolymer in Comparison Example 2, the peel strengths at 180° C. are higher than Examples 1-4.

The glues of Example 1, Comparison Examples 1 and 2 are applied to the back of a PVC floor covering by a back glue machine under 160° C. The performance of the product thus obtained is determined. The test methods and results are summarized in the table immediately below.

Back-Glue Performance Test:

| | Items | Methods | Results |
|---|---|---|---|
| Ex. 1 | Back glue tension (23° C./24 H) | NF T 76-126 | 0.15 daN/cm |
| | Back glue tension (70° C./72 H) | NF T 76-126 | 0.21 daN/cm |
| | Back glue tension (after soaked in water for 24 H) | NF T 76-126 | 0.10 daN/cm |
| Comp. | Back glue tension (23° C./24 H) | NF T 76-126 | 0.63 daN/cm |
| Ex. 1 | Back glue tension (70° C./72 H) | NF T 76-126 | 0.41 daN/cm |
| | Back glue tension (after soaked in water for 24 H) | NF T 76-126 | 0.32 daN/cm |
| Comp. | Back glue tension (23° C./24 H) | NF T 76-126 | 1.13 daN/cm |
| Ex. 2 | Back glue tension (70° C./72 H) | NF T 76-126 | 0.79 daN/cm |
| | Back glue tension (after soaked in water for 24 H) | NF T 76-126 | 0.45 daN/cm |

Repeated Tiling Test:

Methods:

1. A 5*20 cm product is applied to a smooth cement ground at 23° C., and then pressed with a 6 kg steel roller for 10 times. The product is then peeled off the ground and measured for back glue tension under standard NF T 76-126 (23° C./24 H). In the meantime, it is checked whether residual glue is present on the ground.

2. A 5*20 cm product is applied to a smooth cement ground at 23° C., and then pressed with a 6 kg steel roller for 10 times. The product is then peeled off the ground and tiled again to the ground. Again, a 6 kg steel roller is used to press the product for 10 times. The product is then peeled off and measured for back glue tension under standard NF T 76-126 (23° C./24 H). In the meantime, it is checked whether residual glue is present on the ground.

3. This method is substantially same with the method of item 2 except that the cycle that the product is tiled to and peeled from the ground is repeated more times.

Results are shown in the table below.

The back glue tension of the glue of Example 1 was retained to 0.10 daN/cm after the glue was subjected to repeated tiling for 11 times and there did not show any residual glue on ground or glue damage. However, the glue of Comparison Example 1 was prone to be torn and leave residual glue on ground, because unhydrogenated petroleum resin with low softening point (<120° C.) was Used, resulting in lower cohesion value and higher adhesive strength.

The glue of Comparison Example 2 was also prone to be torn and leave residual glue on ground, because styrene-isoprene-styrene block copolymer (SIS) was used, resulting lower cohesion value and higher adhesive strength. Therefore, the glues of Comparison Examples 1 and 2 were damaged after one time tiling and separation, leaving residual glues on ground. After the tiling was repeated for three times, too much residual glues were present on ground, thus their tests were terminated.

The above description is only preferable embodiments of the present invention. It should be noted that, for those skilled in the art, more modifications and improvements can be made on the premise of the technical principle of the present invention, which all shall be incorporated within the protective scope of the present invention.

| | Example 1 | | | Comp. Ex. 1 | | | Comp. Ex. 2 | | |
|---|---|---|---|---|---|---|---|---|---|
| | Back glue | Glue | | Back glue | Glue | | Back glue | Glue | |
| Tiling | tension | residue on | Glue | tension | residue on | Glue | tension | residue on | Glue |
| times | (23° C./24 H) | ground? | damaged? | (23° C./24 H) | ground? | damaged? | (23° C./24 H) | ground? | damaged? |
| One time | 0.16 daN/cm | No | No | 0.62 daN/cm | Yes | Yes | 1.18 daN/cm | Yes | Yes |
| Two times | 0.16 daN/cm | No | No | 0.33 daN/cm | Yes | Yes | 0.72 daN/cm | Yes | Yes |
| Three times | 0.15 daN/cm | No | No | 0.36 daN/cm | Yes | Yes | 0.62 daN/cm | Yes | Yes |
| Four times | 0.16 daN/cm | No | No | | | | | | |
| Five times | 0.14 daN/cm | No | No | | | | | | |
| Six times | 0.14 daN/cm | No | No | | | | | | |
| Seven times | 0.13 daN/cm | No | No | | | | | | |
| Eight limes | 0.12 daN/cm | No | No | | | | | | |
| Nine times | 0.11 daN/cm | No | No | | | | | | |
| Ten times | 0.10 daN/cm | No | No | | | | | | |
| Eleven times | 0.10 daN/cm | No | No | | | | | | |

1. A glue comprising by weight:
styrene-ethylene/butylene-styrene block copolymer 15-30%;
amorphous poly alpha olefin 2-20%;
hydrogenated petroleum resin 20-40%;
liquid isobutylene homopolymer 1-10%;
mineral oil 20-50%; and
antioxidants 0.1-2%.

2. The glue of claim 1, wherein the hydrogenated petroleum resin has a softening point between about 120° C. and about 140° C.

3. The use of the glue of claim 1 as a back-glue of a PVC floor.

4. The use of the glue of claim 2 as a back-glue of a PVC floor.

5. A method for using the glue of claim 1 comprising a step of applying the glue to a bottom surface of a piece of PVC floor under a temperature of 150-180° C.

6. A method for using the glue of claim 2 comprising a step of applying the glue to a bottom surface of a piece of PVC floor under a temperature of 150-180° C.
